(19) United States
(12) Patent Application Publication
(10) Pub. No.: US 2005/0044167 A1
(43) Pub. Date: Feb. 24, 2005

(54) Network information processing system and network information processing method

(76) Inventors: Youichi Kobayashi, Tokyo (JP); Hideharu Fujiyama, Chiba (JP); Yoshinori Oogaki, Chiba (JP); Takanobu Ujisato, Tokyo (JP)

Correspondence Address: William S Frommer;Frommer Lawrence & Haug, 745 Fifth Avenue, New York, NY, 10151, US

(21) Appl. No.: 10/489,466

(22) PCT Filed: Sep. 13, 2002
(86) PCT No.: PCT/JP02/09396

(30) Foreign Application Priority Data
Sep. 14, 2001 (JP) 2001280296
Sep. 14, 2001 (JP) 2001280298

(51) Int. Cl. G06F 15/16

(52) U.S. Cl. 709/217

(57) ABSTRACT

The present invention relates to a network information processing system comprising a plurality of information processors having an input operation function, information provision management means for providing electronic information including display information, and communication means for connecting them to each other, wherein the information provision management means is remote-controlled exclusively or cooperatively utilizing the input operation functions of the information processors. Further, the present invention features that a participation right is remotely set for each network information processing system utilizing the input operation functions of the information processors. By such a configuration, a network electronic conference system etc. can be built up easily and many concerned parties can easily attend an electronic conference without exchanging an attachment of a notebook personal computer to a projector etc. Further, the present invention does not require a manager having relations with a network information processing system and enables a holder (attendee) involved in network information processing to set a participation right freely each time the conference is hold and for each network information processing system.

### TECHNICAL FIELD

The present invention relates to a network information processing system and a network information processing method that are well applicable to various kinds of network conference systems, network education systems, network game systems, etc. More specifically, it comprises information provision management means for processing information transferred from an information processor capable of handling presentation materials and providing electronic information contents including display information, in which this information provision management means is remote-controlled utilizing an input operation function of this information processor or any other information processors through communication means. Further, this information provision management means can be remote-controlled exclusively or cooperatively based on an operation instruction from each of these information processors.

For example, each time a conference etc. is held, a holder (attendee) involved in network information processing can freely set a participation right by remote-setting the participation right for each of these network information processing systems and the attendee can be identified for each of the network information processing systems.

### BACKGROUND ART

Recently, a so-called electronic conference system has been often employed by which a presenter (a material presenter) brings into a conference room a presentation material created using a personal computer a presents the material to a plurality of other conference attendees using an electronic device. In this electronic conference system, a display device and a notebook personal computer of the material presenter are connected to each other. As this display device, a data projector is used to display the presentation materials created with the personal computer. To the data projector (hereinafter abbreviated as projector), a notebook personal computer of each presenter is connected through an RGB-color signal cable, so that a screen being displayed on this notebook personal computer is projected to a white wall etc. The presentation material projected on the white wall etc. is pointed by a mouse cursor, which is operated by the presenter. That is, only the materials owned by a briefer are displayed on the white wall etc.

Recently, network-enabled data projector has been available. Such the projector has built-in personal computer functions. According to this projector, the briefer transfers a presentation file from his or her notebook personal computer (hereinafter referred to information processor also) via a network to the projector so that the projector may project and display its contents utilizing the personal computer functions thereof. However, a conventional electronic conference system has the following problems.

\mathring{1} Operations for pointing up contents projected by a projector can be performed only by a person himself or herself who is making a presentation in a conference, so that in order to perform the equivalent operations by any other person, any other device such as a laser pointer must be used together.

\mathring{2} To share one projector by conference attendees, the next presenter must detach a notebook personal computer of the previous presenter from the projector and attach his or her notebook personal computer to it. Operations for this replacement of the notebook personal computers from the projector are troublesome.

\mathring{3} As for a network-enabled data projector also, built-in personal computer functions of the projector (hereinafter referred to as information provision management means also) can be operated only by a person who is explaining his or her materials. Only one of the materials can be presented at a time. It is impossible for him or her to switch to any other person's materials in explanation.

Furthermore, a recent electronic conference system may employ such a system as to set a presenter's participation right. A conventional type of participation right setting is employed to “log in a computer”, “access contents”, etc., by which a manager having a certain privilege sets an identifier for access and a participation right therefor. Therefore, this kind of electronic conference system has the following problems.

\mathring{1} If a conventional approach is employed, the manager has heavy burdens when frequent conferences are held, which is a problem in management and operation. Even if a participation right is set for each conference according to this method, it is necessary for the manager having a certain privilege to set a conference identifier and the participation right in an authentication apparatus for the participation right before the conference is held, and to set an expiry to this set participation right or delete it after the conference is finished.

\mathring{2} Incidentally, although such an approach called a one-time participation right is available as to set a participation right for each log-in (access), the participation right is altered each time if this approach is used, so that this method does not fit to setting of a participation right, which is commonly used by a plurality of persons, or a participation right having a specific expiry. Further, by this method, the system is complicated.

### DISCLOSURE OF THE INVENTION

A first network information processing system related to the present invention comprises at least one information processor having an input operation function and processing arbitrary information, information provision management means for processing at least information transferred from the information processor and providing electronic information contents including display information, and communication means for connecting the information provision management means and each of the information processors to each other. In this system, the information provision management means is remote-controlled exclusively or cooperatively utilizing the input operation function of the information processor.

According to this first system, arbitrary information is processed by the at least one information processor on the basis of the input operation function on the assumption that the information provision management means arranged in, for example, a conference room or a classroom and each of the information processors placed in this conference room or classroom are connected to each other by the wireless communication means. Based on an operation instruction obtained from this information processor, electronic information contents including display information are provided by the information provision management means. Therefore, it is possible to remote-control this information provision management means exclusively or cooperatively based on the operation instructions from each of the information processors placed in a conference room, a classroom, etc. With this, it is possible to build up a network conference system, a network education system, a network game system, etc. easily.

A first network information processing method related to the present invention comprises the steps of connecting to each other at least one information processor having an input operation function and processing arbitrary information and information provision management means for processing at least information transferred from the information processor and providing electronic information contents including display information. Based on the input operation obtained from this information processor, the information provision management means is remote-controlled exclusively or cooperatively.

By this first method, the information provision management means can be remote-controlled exclusively or cooperatively based on, for example, a wireless operation instruction obtained from each of the information processors brought in a particular region or location such as a conference room or a classroom. It is thus possible to easily build up a variety of kinds of network conference systems, network education systems, network game systems, etc.

A second network information processing system related to the present invention comprises at least one information processor having an input operation function and processing arbitrary information, information provision management means for processing at least information transferred from the information processor and providing electronic information contents including display information, and communication means for connecting the information provision management means and each of the information processors to each other. In this system, utilizing the input operation function of the information processor, a participation right is set remotely for each of the present network information processing systems.

According to the second system, utilizing the input operation function of the information processor, a participation right is set remotely for each of the network information processing systems on the assumption that the information provision management means arranged in, for example, a conference room or a classroom and each of the information processors placed in this particular region or location are connected to each other by, for example, the communication means. Therefore, the present network information processing system does not require a manager having relations therewith, thus permitting a holder (attendee) involved in network information processing to set a participation right freely each time a conference is held. Furthermore, it is possible also to specify the attendees for each of the network information processing systems.

A second network information processing method related to the present invention comprises the steps of connecting at least one information processor and information provision management means to each other using communication means, the information processor having an input operation function and processing arbitrary information and the information provision management means processing at least information transferred from the information processor and providing electronic information contents including display information, and remotely setting a participation right for each network information processing system comprising the information processor, the information provision management means, and the communication mean, by utilizing the input operation function of the information processor.

According to the second method, the network information processing system does not require a manager having relations therewith, thus permitting a holder (attendee) involved in network information processing to set a participation right freely each time a conference is held. Furthermore, it is possible to identify attendees for each of the network information processing systems.

### BRIEF DESCRIPTION OF THE DRAWINGS

FIG. 1 is a block diagram for showing a configuration example of a network information processing system 100 according to an embodiment related to the present invention;

FIG. 2 is a flowchart for showing an example of building up the network information processing system 100;

FIG. 3 is a conceptual diagram for showing a wireless electronic conference system 101 according to a first implementation example related to the present invention;

FIG. 4 is an image view for showing a display example of a GUI-activation-time screen P0 at a notebook personal computer PCi;

FIG. 5 is a block diagram for showing an internal configuration example of a communicator 3;

FIG. 6 is a block diagram for showing a network-type electronic conference system according to a second implementation example related to the present invention;

FIG. 7 is an image view for showing a display example of a GUI-operation screen P1 at the notebook personal computer PCi;

FIG. 8 is a table for showing an example of contents of validity mouse pointer table;

FIG. 9 is a flowchart for showing an example of processing at the notebook personal computer PCi;

FIG. 10 is a flowchart for showing an example of processing at the communicator 3;

FIG. 11 is a conceptual diagram for showing a configuration example of an electronic conference system 103 provided with an attendee controller according to a third implementation example related to the present invention;

FIG. 12 is a flowchart for showing an example of processing (when a conference is attended) at the notebook personal computer PCi;

FIG. 13 is a flowchart for showing an example of processing (when a conference is started) at the communicator 3A etc.;

FIG. 14 is a flowchart for showing an example of processing (when a conference is finished) at the communicator 3A etc.;

FIG. 15 is an image view for showing a display example of the GUI-operation screen P1 at the notebook personal computer PCi according to a fourth implementation example related to the present invention;

FIG. 16 is an image view for showing a configuration example of software in an electronic conference system 102;

FIG. 17 is a block diagram for showing a configuration example of a network information processing system 200 according to a sixth implementation example related to the present invention;

FIG. 18A is an image view for showing a display example of the GUI-operation screen P1 at a console PC43 etc.;

FIG. 18B is a table for showing an example of a situation example of the operating right at the console PC43 etc.;

FIG. 19 is a flowchart for showing an example of processing of mouse operations at the console PC43 etc.; and

FIG. 20 is a flowchart for showing an example of processing at target PCs46-49 etc.

### BEST MODE FOR CARRYING OUT THE INVENTION

It is an object of the present invention to provide a first network information processing system and network information processing method for enabling a network electronic conference system etc. to be easily built up and permitting a number of persons concerned to easily participate in network processing without detaching and attaching their information processor from and to information provision management means one by one.

It is another object of the present invention to provide a second network information processing system and network information processing method for permitting a holder (attendee) involved in network information processing to freely set a participation right each time a conference is held and enabling attendees for each network information processing system to be identified.

The following will describe one embodiment of the network information processing system and the network information processing method related to the present invention with reference to drawings.

### (1) EMBODIMENT

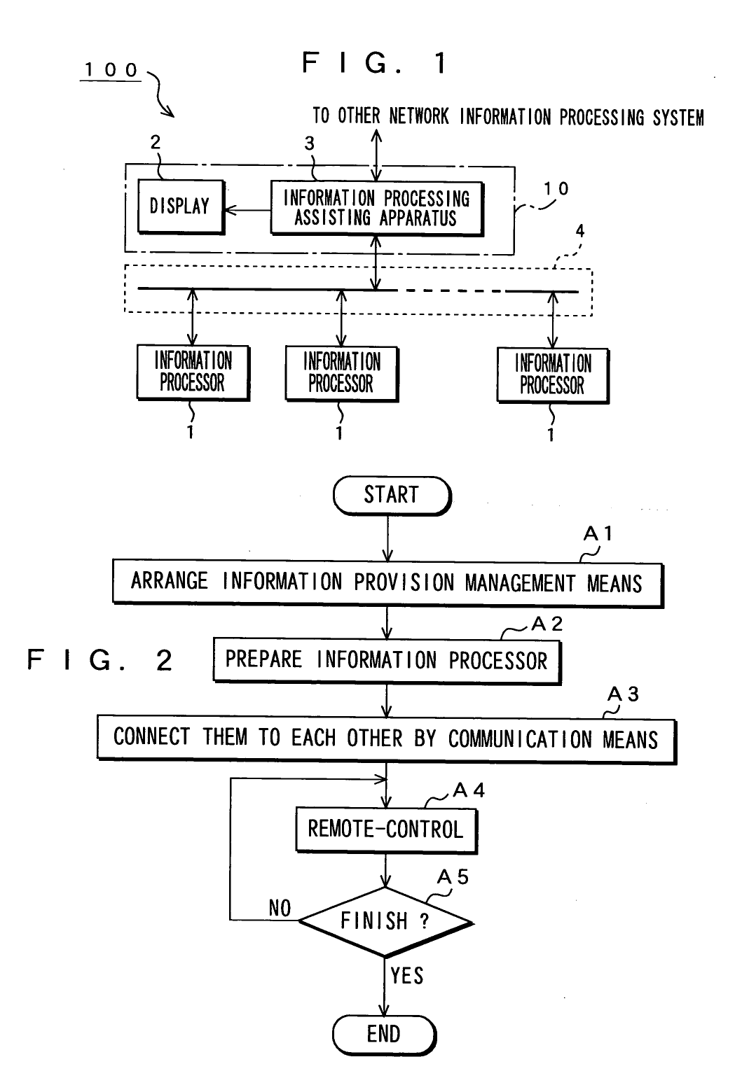

FIG. 1 is a block diagram for showing a configuration example of a network information processing system 100 according to an embodiment related to the present invention.

According to the present embodiment, information provision management means for processing information transferred from an information processor capable of handling presentation materials and providing electronic information contents including display information is provided and remote-controlled through communication means utilizing an input operation function of this information processor or any other information processor so that this information provision management means can be remote-controlled exclusively or cooperatively based on an operation instruction obtained from each of the information processors.

The network information processing system 100 shown in FIG. 1 is well applicable to a variety of kinds of network conference systems, network education systems, network game systems, etc. This system 100 has such a configuration that information provision management means 10 is arranged in a particular region or a particular location such as a conference room, at least one information processor 1 is provided in this particular region or location, and this information provision management means 10 and each of the information processors 1 are connected to each other by communication means 4, thereby allowing the information provision management means 10 to be remote-controlled on the basis of an operation instruction obtained from these information processors 1.

The information processor 1 has a graphic user interface (hereinafter referred to as GUI functions), which is one of the input operation functions, so that by utilizing the GUI functions and mouse operation functions, arbitrary information may be processed. As the information processor 1, an easy-to-carry-about notebook type personal computer (hereinafter referred to as notebook personal computer) is used. To enter an electronic conference system etc., a dedicated application is installed in the notebook personal computer. The information provision management means 10 processes at least information transferred from this information processor 1 and provides electronic information contents including display information.

This information provision management means 10 and each of the information processors 1 are connected to each other by the communication means 4. By utilizing the input operation function of the information processor 1, the information provision management means 10 is remote-controlled. The information provision management means 10 has a display 2 and an information processing assisting apparatus 3. The information processing assisting apparatus 3 assists electronic information processing including the display 2 based on a remote-control instruction obtained from the information processor 1. The information processing assisting apparatus 3 has personal computer functions and processes information using the input operation function of the information processor 1.

Images are displayed on this display 2 based on information obtained from the information processor 1. As the display 2, a projector, a flat panel display, etc. are used. The projector projects color images on a white wall based on R (red color), G (green color), and B (blue color) color signals. As the flat panel display, a plasma display etc. capable of large screen display is used.

This system 100 assumes a case where the information processing assisting apparatus 3 is provided with a wireless communication feature and the information processors 1 are each provided with the wireless communication feature to thereby constitute the commutation means 4, a case where a wireless apparatus is provided as an access point to constitute the communication means 4, and a case where an ordinary communication cable is used to constitute the communication means 4. Of course, these may be combined to constitute a network. As the wireless communication feature, a wireless LAN card is used. In a case where a wireless LAN card is used, the information processing assisting apparatus 3 and each of the information processors 1 can be coupled to each other in a peer-to-peer mode in a particular region or a particular location. No access point is necessary.

In this system 100, the information processors 1 are each assigned an IP address, which is one example of individual identification information so that the information processing assisting apparatus 3 may manage and control each of the information processors 1 based on the IP address. It is done so in order to recognize network-constituent electronic devices connected to the same network as well as the information processors 1 of conference attendees etc. It is thus possible to reduce consumption of global addresses.

In this system 100, to each of the information processors 1, security information is set, which is one example of operation-restrictive information that can be released by specific key information. By thus setting the security information, even if trial is made to access the information processing assisting apparatus 3 in a relevant conference room from the information processor 1 in another room, this information processing assisting apparatus 3 cannot be operated unless the security information is released, thus preventing access by those having no relations with a relevant conference etc. That is, interception of wireless transmission is impossible unless the security information is released. This security system enables a conference to prevent a leakage of secretes therefrom.

The following will describe an example of building up the network information processing system 100. First, at step Al of a flowchart shown in FIG. 2, the information provision management means 10 is arranged in a particular region or a particular location. The particular region includes of residential areas and unit regions such as prefecture and city governments, wards and municipalities. It is done so in order to build up an at-home electronic conference system, an at-home education system, a nation-wide electronic conference system, etc. Then, the process goes to step A2, where at least one information processor 1 is prepared in this particular region or location. It is done so in order to submit presentation materials to an electronic conference system, an electronic classroom system, etc. and explain the materials in this system 100. Then, the process goes to step A3, where the information provision management means 10 and each of the information processors 1 are connected to each other by the communication means 4. For example, to build up the system 100 in a conference room etc., the information provision management means 10 and each of the information processors 1 are connected to each other by a wireless LAN card etc. Then, the process goes to step S4, where the information provision management means 10 is remote-controlled exclusively or cooperatively based on a wireless operation instruction obtained from the information processor 1. At step A5, the process finishes remote control of the information provision management means 10 by the information processors 1 based on user's termination decision.

As described above, according to the network information processing system 100 as an embodiment related to the present invention, arbitrary information is processed on the basis of an input operation at the at least one information processor 1 on the assumption that the information provision management means 10 arranged in a particular region or a particular location such as a conference room and each of the information processors 1 placed in this particular location such as a conference room are connected to each other by the communication means 4. Based on an operation instruction obtained from this information processor 1, electronic information contents including display information are transferred from the information provision management means 10. Therefore, based on operation instruction from each of the information processors 1 brought in a particular region or location such as a conference room or a classroom, this information provision management means 10 can be remote-controlled commonly with the other information processors 1. It is thus possible to easily build up a variety of kinds of network conference systems, network education systems, network game systems, etc.

### (2) FIRST IMPLEMENTATION EXAMPLE

According to the first implementation example, a wireless electronic conference system 101, which is one of the network information processing systems, is built up. In this system 101, as the information processor, an easy-to-carry-about notebook personal computer PCi (i=l−n) is used.

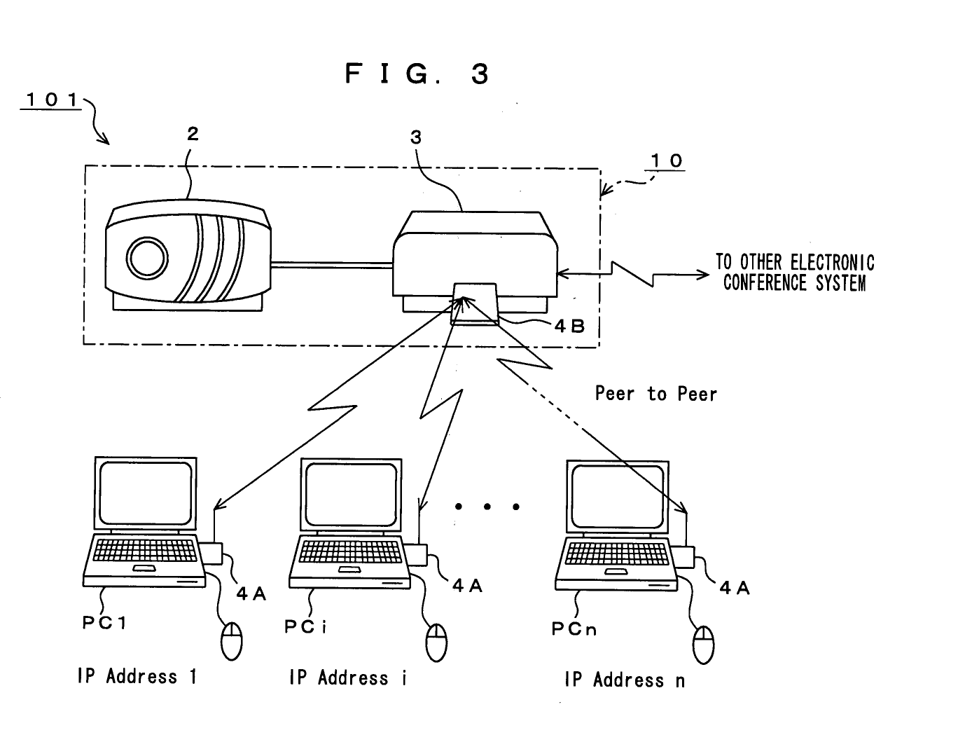

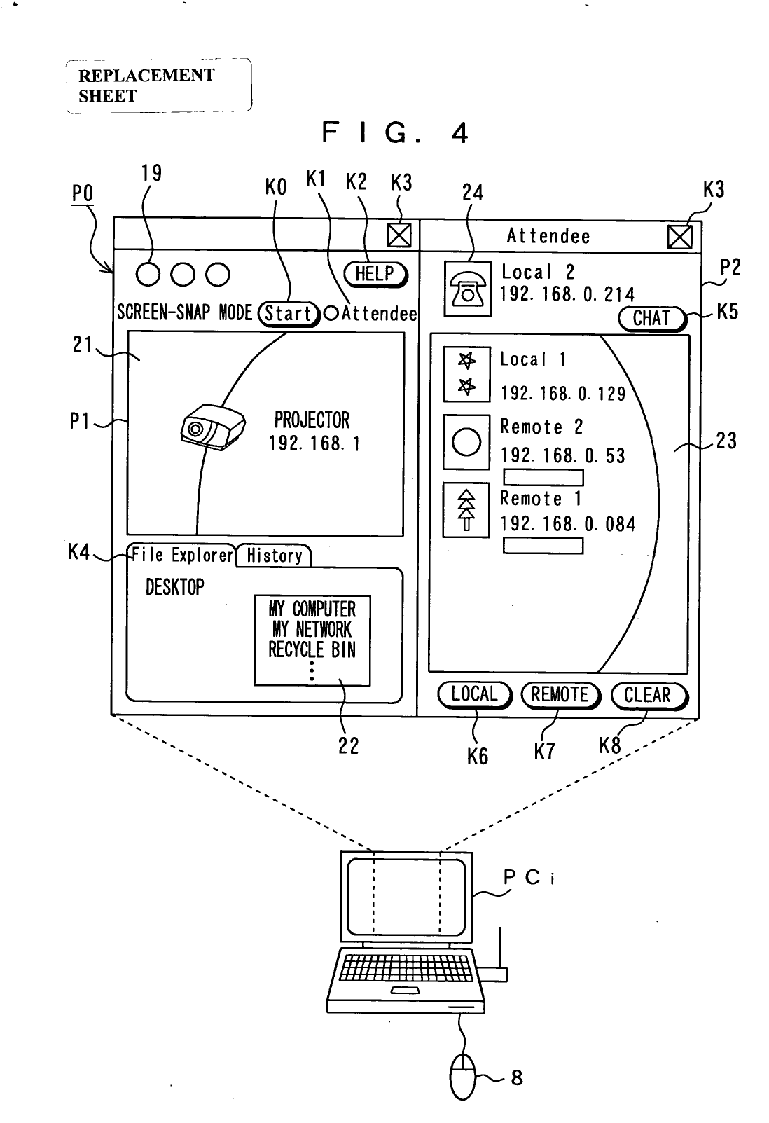

In the wireless electronic conference system (e-conference) 101 shown in FIG. 3, a presentation apparatus 10, which is one example of information provision management means, is arranged in a conference room and, in this conference room, at least one notebook personal computer PCi is prepared in such a configuration that this presentation apparatus 10 and each of the notebook personal computers PCi are connected to each other by wireless LAN cards 4A and 4B (in a Peer-to-Peer mode), which are one example of communication means, by which based on operation instructions obtained from these notebook personal computers PCi, the presentation apparatus 10 can be remote-controlled exclusively or cooperatively (first network information processing system).

The notebook personal computer PCi processes arbitrary information utilizing GUI functions and mouse operation functions. For example, images are displayed at the presentation apparatus 10 only by dragging and dropping a file created by Microsoft Power Point, Excel, or Word or a file in a PDF, JPEG, or GIF format on an operating screen at the notebook personal computer PCi.

Further, a desktop or an active window is captured and displayed at the presentation apparatus 10 or chatting (message exchange) is performed or files are transferred between conference attendees. Besides, this notebook personal computer PCi is used to conduct remote control on a TV conference system including power turn-ON/OFF, connection or disconnection of network-constituent electronic devices, and switchover of input signals. It is done so in order to make a presentation easily and smoothly.

At this presentation apparatus 10, at least information transferred from this notebook personal computer PCi is processed and electronic information contents including display information are provided. This presentation apparatus 10 and each of the notebook personal computers PCi are connected to each other through the wireless LAN cards 4A and 4B and used. The GUI functions of the notebook personal computer PCi are utilized to remote-control the presentation apparatus 10 exclusively or cooperatively.

The presentation apparatus 10 has a data projector (hereinafter referred to as projector simply) 2, which is one example of the display, and a communicator 3, which is one example of the information processing assisting apparatus. The communicator 3 assists electronic information processing including the projector 2 in based on remote-control instructions from the notebook personal computer PCi. The communicator 3 has personal computer functions and processes information using the input operation function of the notebook personal computer PCi.

At this projector 2, images are displayed on the basis of information obtained from the notebook personal computer PCi. The projector 2 projects color images on a white wall etc. based on RGB color signals. The presentation apparatus 10 is not limited to such a configuration that it is split into the projector 2 and the communicator 3. Such a configuration may be accepted that the personal computer functions of the communicator 3 are built in the projector 2 to constitute this apparatus 10 as a network-enabled display.

In this system 101, the notebook personal computers PCi are each assigned an IP address so that the communicator 3 may manage and control the notebook personal computers PCi etc. based on the IP address. It is done so in order to recognize network-constituent electronic devices as well as the notebook personal computers PCi of conference attendees, which are connected to the same network.

In this system 101, to each of the notebook personal computers PCi, security information that can be released by specific key information is set, so that even if a trial is made to access the communicator 3 in a relevant conference room from the information processor in another conference room, this communicator 3 cannot be operated unless the security information is released, thus preventing access by those having no relations with a relevant conference etc. By this security system, an electronic conference system can be protected.

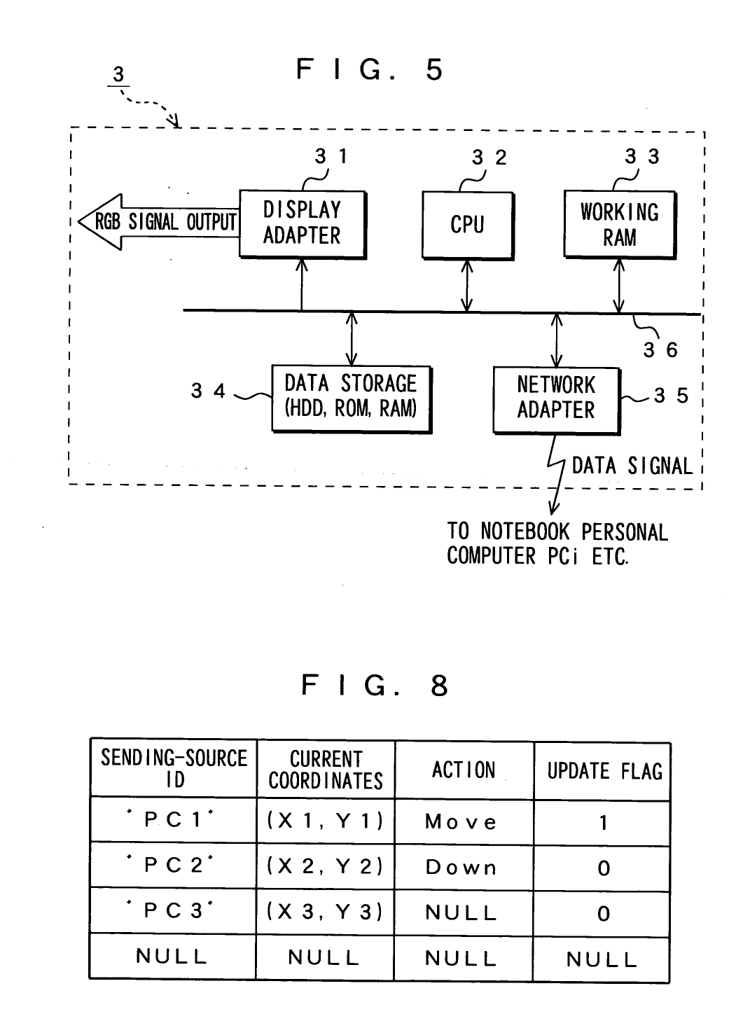

The following will describe a display example of a GUI-operation screen upon activation (hereinafter referred to as GUI-activation-time screen also) PO at the notebook personal computer PCi. The GUI-activation-time screen PO shown in FIG. 4 is displayed on the notebook personal computer PCi upon activation and provides a display example based on a client GUI program. The GUI-activation-time screen PO employs a split-by-two display system. On the left side in the screen PO, a GUI-operation screen (control screen) P1 is displayed and, while on the right side in it, an attendee screen P2 is displayed. In this example, on the GUI-operation screen P1, a selection screen due to a screen-snap mode is displayed.

On the GUI-operation screen P1, at its middle an area 21 for device icons is provided to display icons of projectors etc. Above this area 21, a “start” or “stop” button KO in the screen-snap mode is displayed. In its right-side neighbor an attendee button K1 is displayed and, above it a “HELP” button K2 is displayed, and in an outer frame above this GUI-operation screen P1 a “close” button K3 is displayed. Below the area 21, a tab K4 for “file explorer/history” is displayed and file list area 22 is displayed in this tab K4. Note here that at the left top corner above the GUI-operation screen P1, a logo mark 19 representing an enterprise image can be displayed.

On this attendee screen P2, at its middle an area 23 for an attendee user list is provided to display IP addresses etc. of conference attendees or their notebook personal computers PCi together with the icons thereof. Above this area 23, a user's information area 24 is provided by which a local side may display an IP address of a particular notebook personal computer PCi. On the right side above the attendee screen P2, a “chat” button K5 is displayed. Further, below the attendee screen P2, a local button K6, a remote button K7, a clear button K8, etc. are displayed.

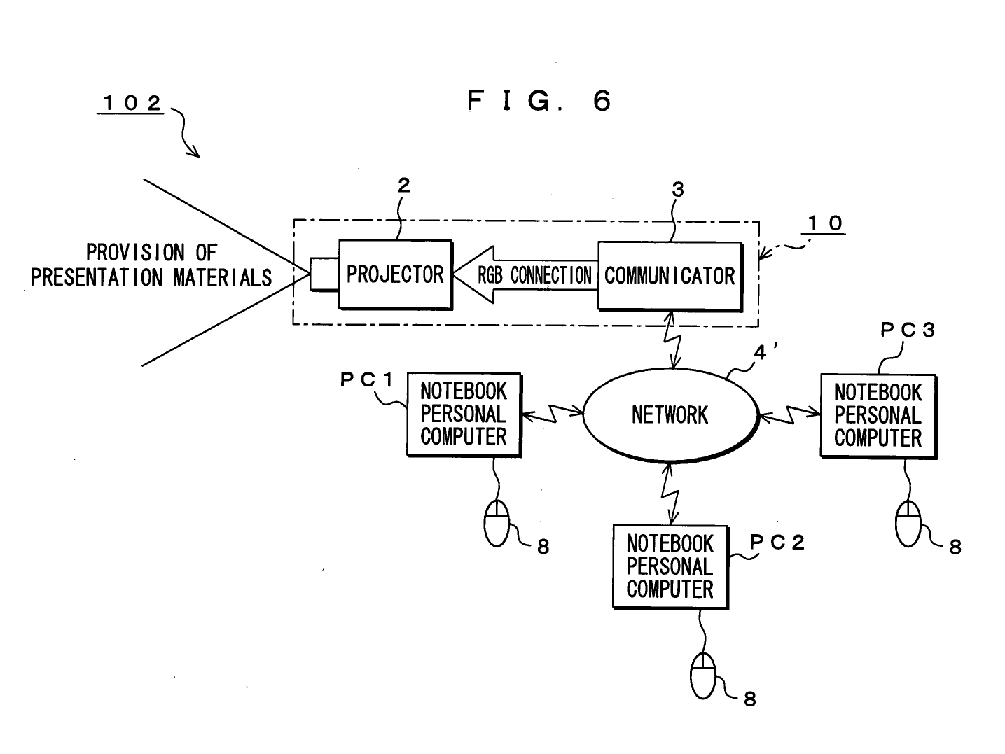

The following will describe an internal configuration example of the communicator 3. The communicator 3 shown in FIG. 5 has personal computer functions and is adapted to process information by mouse operations at the notebook personal computer PCi. The communicator 3 has a data bus 36 to which a display adapter 31, a CPU32, a working RAM33, a data storage 34, a network adapter 35, etc. are connected.

The display adapter 31 has a function to process presentation materials and create RGB color signals. The RGB color signals based on these presentation materials are output to the projector 2. The working RAM33 temporarily stores private IP addresses and transfer information related to presentation materials.

The data storage 34 is constituted of a hard disk (HDD), an ROM, and an RAM, which are not shown. The hard disk is used to store the presentation materials. In the ROM , a control program (hereinafter referred to as system assisting control program) for assisting electronic conference systems is written. The system assisting control program is composed of basic software for operating the CPU32 and programs which process presentation data.

The network adapter 35 is used to transmit presentation data and various commands to and receive them from the notebook personal computer PCi. The CPU32 controls input/output operations of the display adapter 31, the working RAM33, the data storage 34, the network adapter 35, etc. based on the system assisting control program.

The following will describe an example of operations in the wireless electronic conference system 101. In this example, such a case is assumed that the system assisting control program (dedicated application) is installed in the communicator 3 and another dedicated application program is installed also in the notebook personal computer PCi of a conference attendee beforehand. Further, the presentation apparatus 10 constituted of the communicator 3 connected to the projector 2 is arranged in a conference room. These apparatuses are powered. It is done so in order to build up the electronic conference system 101 etc.

Then, at least one notebook personal computer PCi is prepared in the conference room. Preferably each of the conference attendees brings the notebook personal computer PCi with him. This is because a person who makes a presentation of materials (hereinafter referred to as presenter) submits a presentation material in this electronic conference system 101 and presents the materials in this system 101. Then, a conference attendee sets an access destination of the wireless LAN card 4A of the notebook personal computer PCi to the wireless LAN card 4B of the communicator 3. In this case, a security key is used. Then, by utilizing dedicated application software installed in the communicator 3 and peer-to-peer mode functions of the communicator 3, a private IP address is assigned to the notebook personal computer PCi.

Then, from the notebook personal computer PCi, based on the dedicated application software, the presentation materials in this personal computer PCi are transferred to the communicator 3. In this case, based on a mouse-operation instruction obtained from the notebook personal computer PCi, electronic information contents including display information are transferred from the communicator 3 to the projector 2. The electronic information contents are transferred by outputting the RGB color signals from the communicator 3 to the projector 2. The materials projected by the projector 2 are remote-controlled by mouse operations from the notebook personal computer PCi of the presenter. In this case, based on the mouse operations, the materials are explained on an image through the projector 2. Then, based on presenter's ending decision, remote control on the presentation apparatus 10 by the notebook personal computer PCi is finished.

In such a manner, according to the wireless electronic conference system 101 of the first implementation example related to the present invention, on the assumption that the communicator 3 that constitutes the presentation apparatus 10 arranged in a conference room etc. and each of the notebook personal computers PCi placed in this conference room are connected to each other by the wireless LAN 4A and 4B, arbitrary information is processed based on mouse operations at the notebook personal computer PCi of the presenter of the presentation material. Therefore, based on operation instructions obtained from each of the notebook personal computers PCi brought in a conference room, a classroom, etc., this presentation apparatus 10 can be remote-controlled exclusively against or cooperatively by the other notebook personal computers PCi. It is thus possible to easily build up a variety of kinds of network conference systems, network education systems, network game systems, etc.

(3) SECOND IMPLEMENT EXAMPLE

In this implementation example, by utilizing input operation functions of a notebook personal computer PCi of a presenter and the notebook personal computers PCi of other conference attendees, presentation apparatuses 10 can be remote-controlled simultaneously. That is, simultaneous-multiple connectivity due to network connection of the notebook personal computers PCi is utilized so that a plurality of conference attendees can indicate the same presentation materials simultaneously.

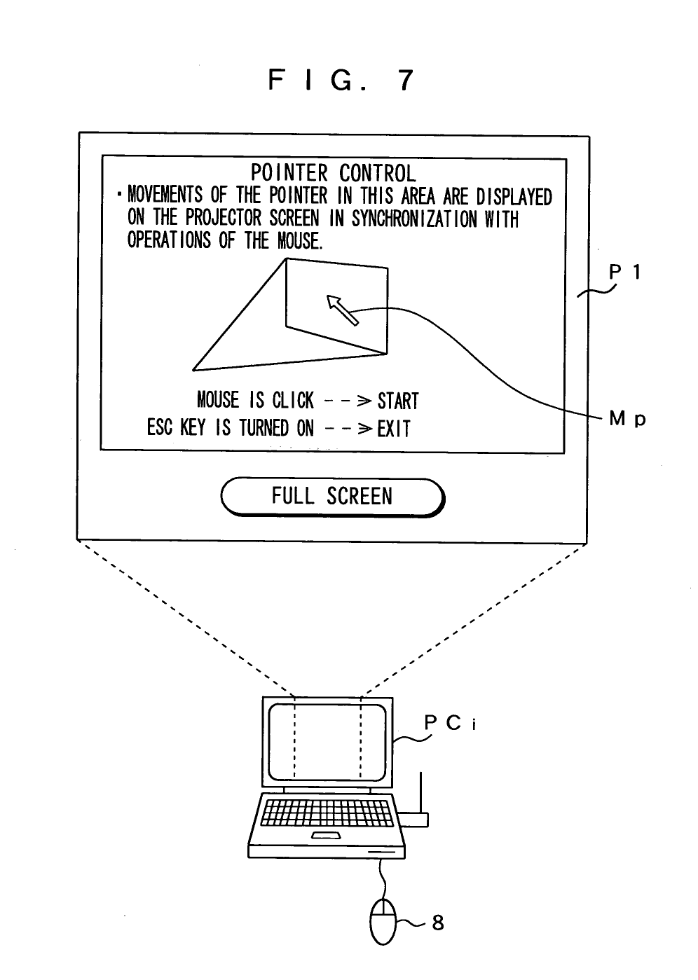

In a network-type electronic conference system 102 shown in FIG. 6, a data-communication network 4′, which is one example of communication means, is provided and the presentation apparatus 10 and, for example, three notebook personal computers PCi (i=1−3) are connected to the data- communication network 4′. Each of the notebook personal computers PCi has a mouse 8 connected thereto. As in the first implementation example, the presentation apparatus 10 is constituted of a projector 2 and a communicator 3. The components indicated by the same reference symbols as those in the first implementation example have the same functions and thus, the description thereof is omitted. As the network 4′, for example, a wired Ethernet (R) LAN or a wireless LAN is used. A notebook personal computer PC1 is operated by, for example, a presenter who makes a presentation and notebook personal computers PC2 and PC3 are operated by the conference attendees other than the presenter.

Further, a GUI-operation screen P1 shown in FIG. 7 is a control screen related to mouse operations and provides contents displayed at the notebook personal computer PCi. The GUI-operation screen P1 is displayed when a file desired to be projected through the projector 2 is dropped to a projector icon, when the projector icon is double-clicked on, or when the projector icon is clicked on with the right mouse button to select REMOTE CONTROL from a display menu. On this GUI-operation screen P1, an image picture of the projector 2 as well as a mouse pointer (indicating pointer) Mp are displayed and a comment is written in English or Japanese.

On this GUI-operation screen P1, below an item name of “POINTER CONTROL”, a sentence “movements of the pointer in this area are displayed on the projector screen in synchronization with operations of the mouse” is written “start” is clicked on with the mouse and an ESC key is turned on to instruct “exit”. It is done so in order to permit a plurality of conference attendees to point the same presentation materials simultaneously.

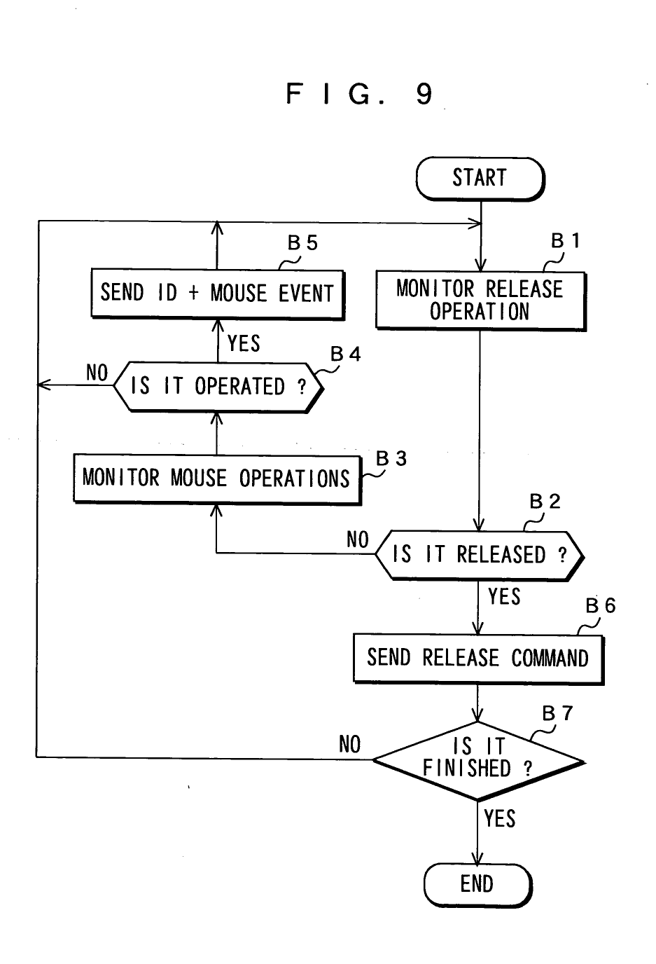

The following will describe an example of contents of a validity mouse pointer table. The validity mouse pointer table shown in FIG. 8 is managed by the communicator 3 and unfolded in, for example, the working RAM33. In this example, the three notebook personal computers PC1-PC3 provide a sending source of mouse operation information, so that PC1-PC3 are written as their sending-source IDs. Current coordinates (X1, Y1) ever-changing with this sending-source ID=PC1 are written. Besides the current coordinates, an action (moving situation) of the mouse 8, an alteration flag, etc. are also written. In this example, for action=Move, “1” is written as the alteration flag.

Similarly, current coordinates (X2, Y2) are written for a sending-source ID=PC2. For action=Down, “0” is written as the alteration flag. Current coordinates (X3, Y3) are written for a sending-source ID=PC3. For action=Null, “0” is written as the alteration flag. Note here that alteration flag=“1” indicates that the mouse 8 has moved in sampling time and “0” indicates that it has not moved. It is thus possible to point the same presentation materials simultaneously using the three notebook personal computers PC1-PC3i of the conference attendees.

The following will describe an example of operations in the network-type electronic conference system 102. In this operation example, such a case is assumed that information of presentation materials is projected through the projector 2. In this example, from the presenter's notebook personal computer PC1 shown in FIG. 6, presentation data is transferred via the network 4′ to the network adapter 35 of the communicator 3 and temporarily stored in the data storage 34 shown in FIG. 5. The system assisting control program is read out from the data storage 34 and loaded into the working RAM33. The CPU32 processes the transferred presentation data based on the system assisting control program. As a result thereof, the presentation data is sent through the display adapter 31 to the projector 2 as RGB color signals, to project the presentation material. In this case, if the presenter moves the mouse pointer Mp into a frame of the GUI screen of the notebook personal computer PCi and, for example, clicks the mouse 8 there, from this point in time onward, movement of the mouse 8 operated in this frame are transferred through the network 4′ to the communicator 3 (first network information processing method).

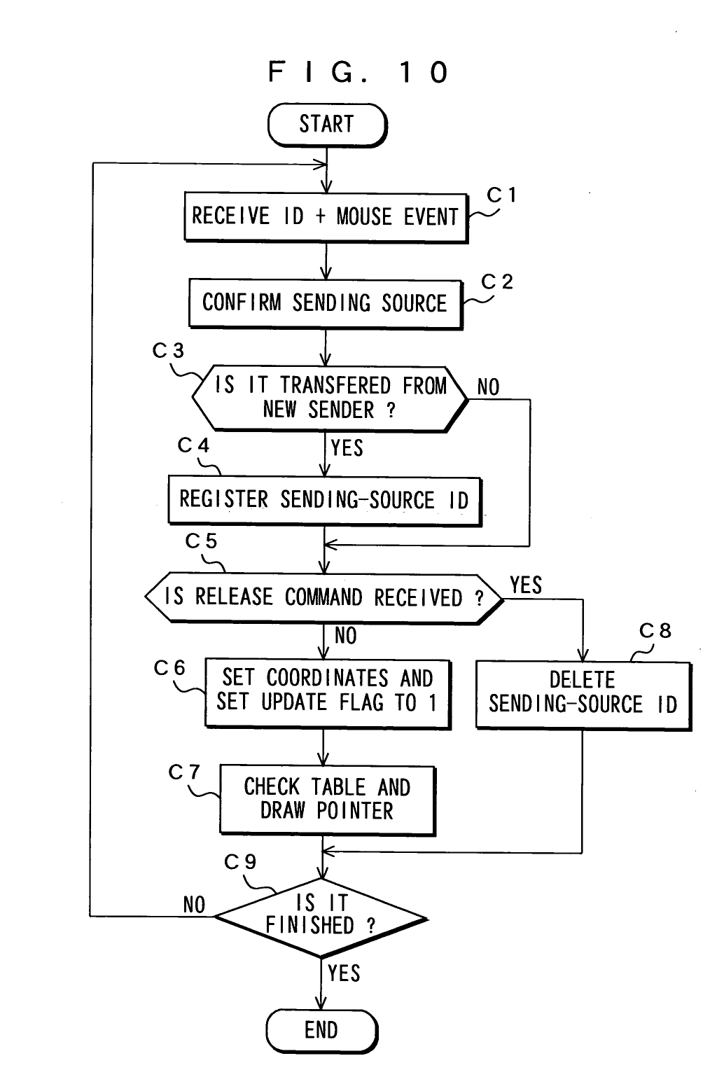

Under these processing conditions, click operations into the mouse control frame are monitored at the attendee's notebook personal computer PCi. For example, at step B1 of a flowchart shown in FIG. 9, a release operation is monitored at the mouse 8 in every constant lapse of time (sampling time). At step B2, the process decides whether the mouse operation is released. If the mouse operation is not released, that is, if mouse operation information (mouse event) is transferred to the communicator 3, the process goes to step B3 to continuously monitor the mouse operation. Then, the process goes to step B4 to decide whether an operation to transfer the mouse operation information is performed. In this decision, the operation of the mouse 8 is sampled in every constant lapse of time. If the transfer operation is not performed after the constant lapse of time , the process returns to step B1 to monitor the release operation. If the mouse operation information transfer operation is performed at step B4, the process goes to step B5 to add a sending-source ID to the mouse operation information and transfer it via the network 4′ to the communicator 3. Then, the process returns to step B1.

If the mouse operation is released at step B2, on the other hand, the process goes to step B6 to send a release command to the communicator 3. It is done so in order to enable file transfer etc. at the other notebook personal computers PCi. Then, the process decides whether the relevant conference is finished at step B7. This decision is made by detecting power-off information etc. If the conference is not finished, the process returns to step B1 to repeat the above-mentioned processing.

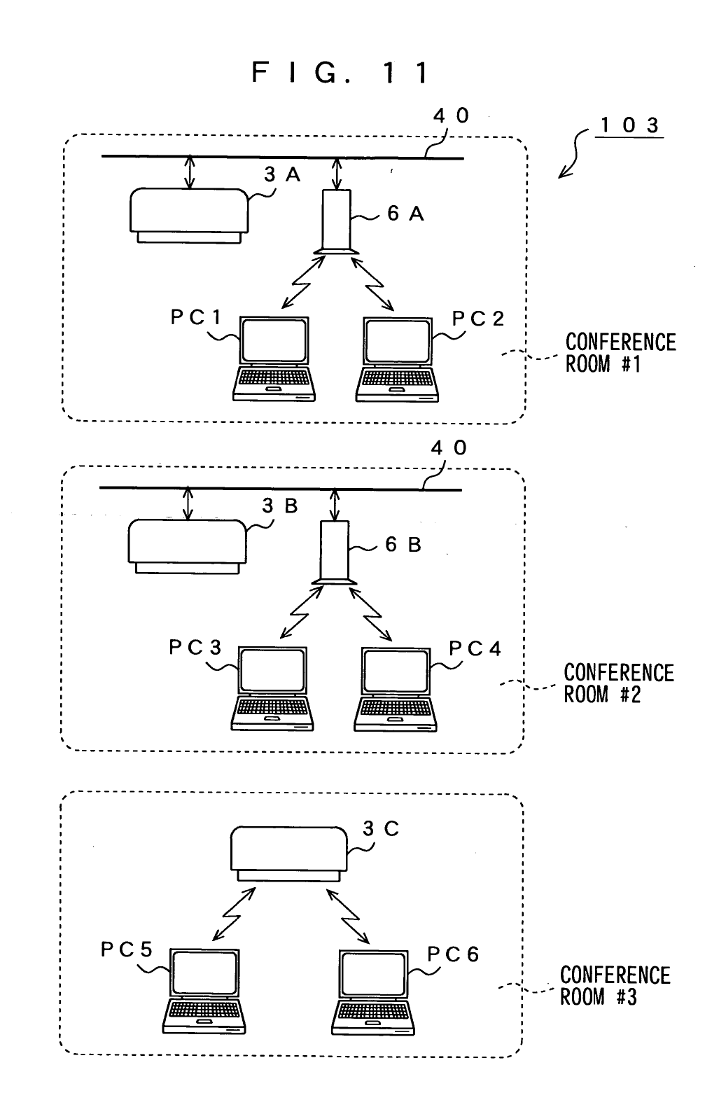

Meanwhile, the communicator 3 represents the operations of the mouse 8 in a shape of the mouse pointer Mp on the display adapter 31 and projects it, thereby showing directive operations of the presenter. That is, the communicator 3 receives a sending-source ID plus mouse operation information at step C1 of a flowchart of FIG. 10 on the assumption that the sending-source ID plus mouse operation information are transferred from the notebook personal computer PCi.

Then, at step C2, the sending source is confirmed. It is confirmed by collating a sending-source ID registered beforehand with a sending-source ID added to the mouse operation information. It is done so in order to accommodate a case where a new sending source transfers the mouse operation information. In this example, the process goes to step C3 to check on whether the information is transferred by a new sending source. If such is the case, the process goes to step C4 to register the new sending source ID into the validity mouse pointer table. If otherwise decided at step C3, that is, if it is decided that the information is transferred by an already registered sending source, the process goes to step C5 to check whether a release command is received. If such is the case, the process goes to step C8 to delete the sending-source ID from the validity mouse pointer table and then goes to step C9.

Note here that if it is decided that no release command is received at step C5, the process goes to step C6 to set coordinates into the validity mouse pointer table. Simultaneously, “1” is set to an update flag for update. In the case of a new sending source, “0” is written. Then, the process goes to step C7 to check the validity mouse pointer table to redraw an altered pointer. Then, the process goes to step C9 to decide whether the relevant conference is finished. This decision is made by detecting power-off information etc. If the conference is not finished, the process returns to step C1 to repeat the above-mentioned processing.

In this implementation example, mouse operations are similarly performed also at the other attendees' notebook personal computers PC2 and Pc3. That is, by permitting the other attendees also to make a presentation (above-mentioned operations) so that such processing as shown in the flowchart of FIG. 9 may be performed, instructions about presentation materials can be given by a plurality of persons simultaneously.

In such a manner, according to a network information processing system of the second implementation example related to the present invention, against the presentation material in current exhibition, simultaneously a plurality of attendees can give instructions (pointing operations) for presentation materials by remote control from their notebook personal computers PC1, PC2, PC3, etc. (simultaneous-multiple connectivity). It is thus possible to utilize an advantage of the simultaneous-multiple connectivity of a network in a network-type electronic conference system 102. In the present implementation example, a plurality of conference attendees can perform directive operations about presentation materials simultaneously. Besides, the following applications may be conceivable.

\mathring{1} Not only directive operations about the materials but also turning over of pages of the materials are possible.

\mathring{2} In a brain storming-type conference, comments etc. in a message transmitted from a conference attendee's notebook personal computer PCi can be consecutively displayed on a dedicated program display screen operating on the communicator 3 and saved as a record by an information creating apparatus such as a creator.

### (4) THIRD IMPLEMENTATION EXAMPLE

According to this implementation example, a participation right is set remotely for each of electronic conference systems 103 utilizing GUI functions of a notebook personal computer PCi, so that a holder (attendee) involved in a conference can freely set the participation right each time a conference etc. is held without requiring a manager having relations with this electronic conference system and the attendee can be identified for each of the conferences (second network information processing system).

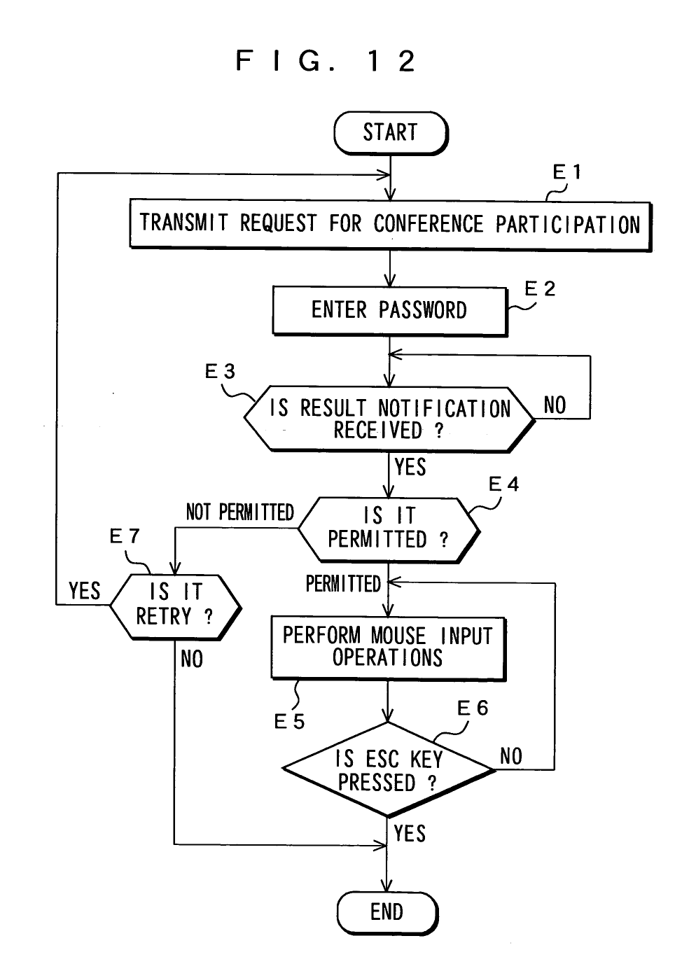

In the electronic conference system 103 provided with an attendee controller shown in FIG. 11, a network information processing system is applied to each of the conference rooms #1, #2, and #3. In the conference room #1, a communicator 3A and an access point 6A are connected to each other by a communication cable 40. The access point 6A is one example of communication means, and as this means, a wireless apparatus is used. For example, through the access point 6A, two notebook personal computers PC1 and PC2 of conference attendees transmit information to and receive it from the communicator 3A. Of course, the number of the notebook personal computers PC1, PC2, . . . used in conference room #1 is not limited to two.

The communicator 3A is one example of information provision management means and has a password authentication function in the same chassis. In addition to this function, a function is provided to process information transferred from the notebook personal computers PC1 and PC2 and provide electronic information contents including display information. This function may be arranged separately from the communicator 3A as, for example, a participation-right authentication apparatus. Thereby, the same effects can be obtained.

In conference room #2, a communicator 3B and an access point 6B are connected by the communication cable 40. In this conference room #2 also, through the access point 6B, two notebook personal computers PC3 and PC4 of conference attendees transmit information to and receive it from the communicator 3B. Of course, the number of the notebook personal computers PC3, PC4, . . . used in conference room #2 is not limited to two. The communicator 3B also has the password authentication function and, besides, processes information transferred from the notebook personal computers PC3 and PC4 and provides electronic information contents including display information.

In conference room #3, a communicator 3C is prepared and two notebook personal computers PC5 and PC6 of conference attendees are arranged to transmit information and receive it from the communicator 3C utilizing a wireless LAN card, not shown, not via an access point. Of course, the number of the notebook personal computers PC5, PC6, . . . used in conference room #3 is not limited to two. The communicator 3C also has the password authentication function and processes information transferred from the notebook personal computers PC5 and PC6 and provides electronic information contents including display information.

In the present implementation example, utilizing the input operation function of the notebook personal computer PCi corresponding to the password authentication function of each communicators C1, the participation right is set remotely for each conference. Each of the communicators 3A-3C remote-controls the participation right for the conference rooms #1, #2, and #3. The communicators 3A-3C collate with each other a participation right which is initially set and participation rights which are set next time and beyond and process information transferred from a notebook personal computer PCi that has the participation right agreed with the initially set participation right.

At each of the communicators 3A-3C, when input operations by a specific notebook personal computer PCi, which is given a participation right, are finished, this participation right is invalidated. In this example, at each of the communicators 3A-3C, after a constant lapse of time from a point in time when the relevant network information processing has been finished, all the participation rights are invalidated.

The following will describe an example of processing in the electronic conference system 103 provided with an attendee controller. In this system 103, utilizing the input operation function of the notebook personal computer PCi, a participation right is set remotely for each of the electronic conference systems, that is, for each conference room. By using such a conference participation right, attendees in a network information processing system can be restricted and a conference holder (first conference attendee) is given a right to freely set the participation right so that the participation rights can be released all at once when the conference is finished (second network information processing method).

[Conference is Started]

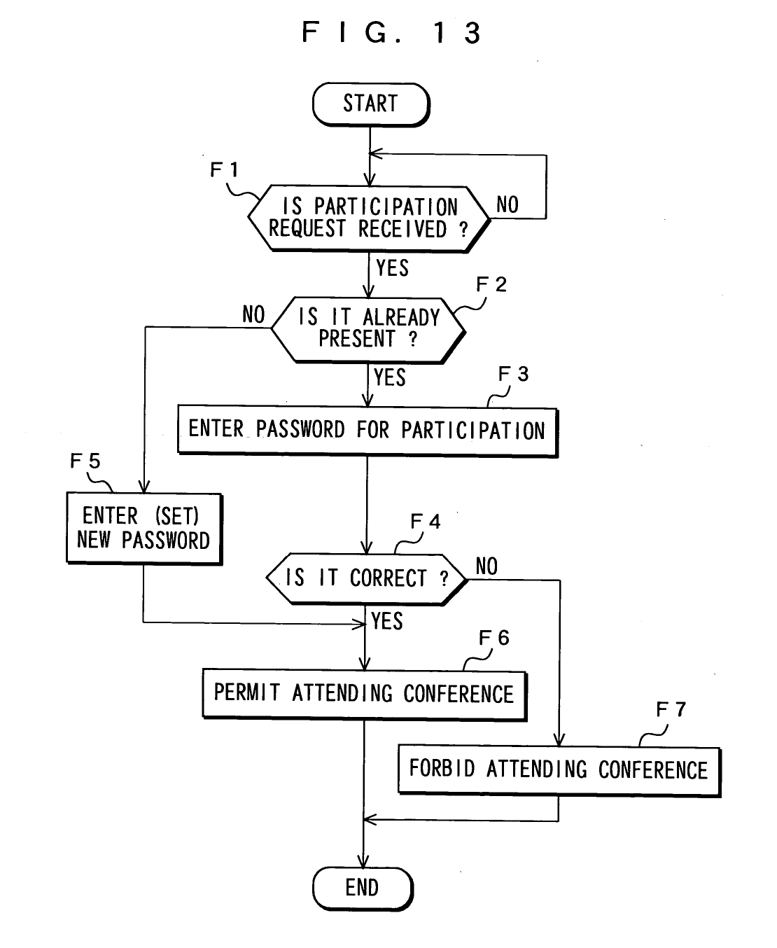

Under these processing conditions, in the case of, for example, the conference room #1, the notebook personal computer PCi transmits a request for conference participation to the communicator 3A at step E1 of a flowchart shown FIG. 12. This request for conference participation is received at the communicator 3A. Then, at step E2, a conference attendee enters a password. This password is received at the communicator 3A. A collation result of this password is transmitted from the communicator 3A to the notebook personal computer PCi. The notebook personal computer PCi receives the password collation result at step E3.

In this example, control branches off from step E4 in accordance with the password collation result. If the conference participation is permitted, the process goes to step E5, where the mouse is used to perform input operations. Then, the process goes to step E6 to check whether an ESC key is pressed. Whether the ESC key is pressed is detected in every constant lapse of time. It is considered that a conference attendee presses the ESC key usually when the conference is finished. Note here that if the conference participation is not permitted at step E4, the process goes to step E7 to waits for an instruction of whether a retrial is to be performed. If such is the case, the process returns to step E1. Otherwise, the process ends the processing.

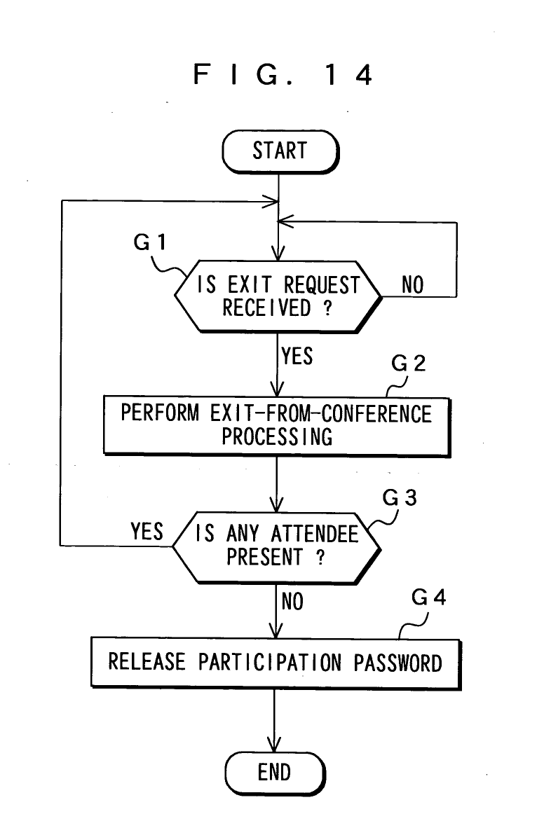

Meanwhile, the communicator 3A etc. are waiting for the request for conference participation from the notebook personal computer PCi at step F1 of a flowchart shown in FIG. 13. When the conference participation request is received from the notebook personal computer PCi etc., the process goes to step F2 to check whether a relevant attendee candidate is already present in a list of attendees. In this case, the communicator 3A references the list of attendees to compate to each other each of already-registered attendees and the attendee candidate related to the currently received request for conference participation. If agreed, he or she is decided to be an already registered attendee. If the attendee candidate is not present in the list, the process goes to step F5, where a new password is entered. It is done so in order to set a password for participation.

If the attendee candidate is present in the list, the process goes to step F3 to receive the participation password from the notebook personal computer PC1. Then, the process goes to step F4 to check whether this participation password is correct. If the password is correct, the process goes to step F6 to permit him or her to attend the conference. If the password is incorrect, the process goes to step F7 to refuse the request for conference participation.

[Conference is Finished]

In this example, at step G1 of a flowchart shown in FIG. 14, the communicator 3A waits for an exit request. If an exit request is received from the notebook personal computer PCi, the process goes to step G2 to perform exit-from-conference processing. In this processing, the process erases a password etc. of an attendee related to the exit from the list of conference attendees. Then, the process goes to step G3. At step G3, the process checks whether there is left a password of any conference attendee. If the conference attendee's password is left, it means that any attendee has yet to exit, so that the process returns to step G1. If it is decided that all of the attendees have exited at step G3, the process releases the participation password. This processing is similarly performed for the conference rooms #2 and #3 also.

In such a manner, according to the electronic conference system 103 provided with an attendee management function of the third implementation example related to the present invention, utilizing the input operation function of the notebook personal computer PCi, a participation right is set remotely for each of these conference rooms #1, #2, and #3. Therefore, a holder (attendee) involved in network information processing can set a participation right freely each time a conference is held, without requiring a manager having relations with each of the conferences. Further, a participation right which is set beforehand can be made valid only when network information is being processed (i.e., when a conference attendee is present) and automatically released when the conference is finished (when there is no conference attendee present any more). With this, the attendees involved in network information processing need not be conscious of releasing of the participation right. Note here that a procedure is unnecessary for releasing of the participation right by the manager. Furthermore, attendees can be identified for each electronic conference system.

### (5) FOURTH IMPLEMENTATION EXAMPLE

According to the present implementation example, in the earlier-mentioned electronic conference system 102, by remote-controlling information record utilizing GUI functions of notebook personal computers PC1 etc., the communicator 3 may keep the information transferred from a plurality of notebook personal computers PC1 and, to this communicator 3, material information etc. obtained from attendees involved in a plurality of network information processing can be transferred smoothly and systematically. Note here that a system configuration employed in the present example is such as shown in FIG. 6 and so the description thereof is omitted.

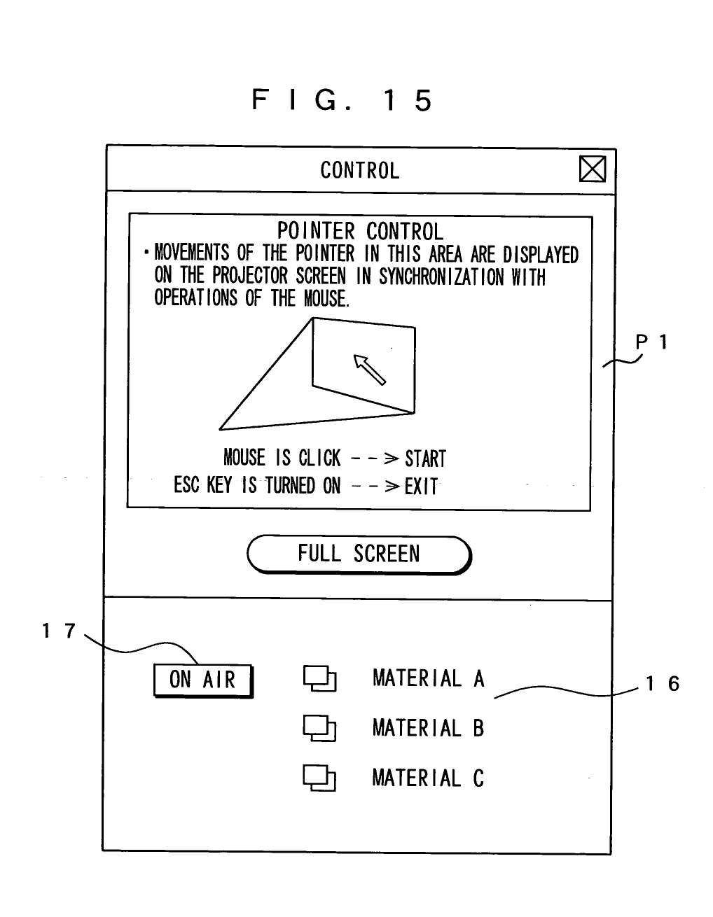

A GUI-operation screen P1 shown in FIG. 15 is displayed on the notebook personal computer PC1 etc. and provides an example of display based on a client GUI program. The GUI-operation screen P1 is one example of a user-selected screen, on which operation information is entered using a mouse 8, which is one example of input means. In FIG. 15, at a bottom of the GUI-operation screen P1, a file list 16 is displayed, which lists materials #1, #2, #3, etc. of files transferred from the notebook personal computer PC1 etc. A “ON Air” mark 17 on its left side indicates a file whose contents are currently projected through the projector.

In this example, remote switchover control is conducted on display information at the communicator 3 utilizing the operation screen P1. It is done so because materials kept in the communicator 3 are switched in display by a plurality of attendees. A list of information kept in the communicator in this example is displayed at the projector 2. At each of the notebook personal computers PC1 etc., an icon image is selected on the GUI-operation screen P1 to enter operation information. In this example, the communicator 3 transfers only capture information when transferring screen information transferred from the notebook personal computer PC1 etc. to another notebook personal computer PC2. The capture information is information of an entire screen or an active window screen.

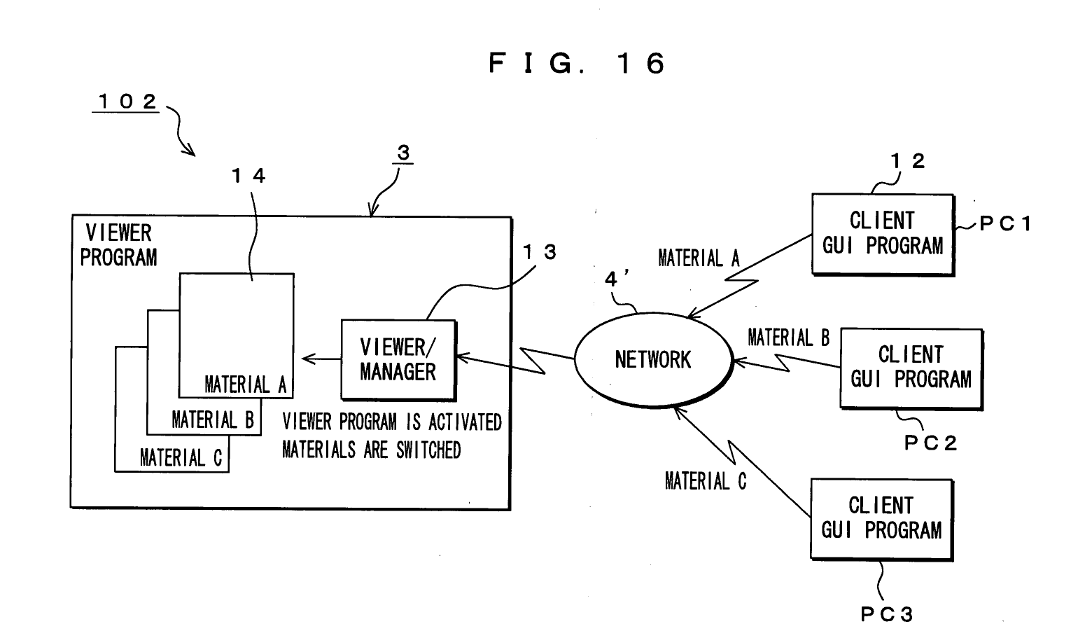

The following will describe a configuration example of software in the electronic conference system 102. According to the configuration example shown in FIG. 16, the notebook personal computer PC1 etc. on the side of a client (which is a conference attendee and corresponds to a presenter) are provided with client GUI programs 12, each of which is used in operations of data file transfer and presentation. A viewer program 14, which is one example of a system assisting control program, is prepared in the communicator 3. The viewer program 14 includes various programs each of which corresponds to each kind of a data file to be processed, to display a plurality of windows so that different data files can be displayed in these different windows. Further, the communicator 3 is provided with a viewer manager (JPEG viewer) 13 that is realized by the CPU32 and the working RAM33 described with reference to FIG. 5, to accept operations from the GUI program 12 of the client, thereby conducting controls on activation of the various programs of the viewer program 14 and switchover of materials.

The following will describe a remote control of information record by use of the GUI functions of the notebook personal computer PC1 etc. in the electronic conference system 102. In this example, to project presentation data through the projector 2, the following processing is performed. First, by operating the client GUI program 12 to drag a file to, for example, the GUI-operation screen P1 and drop it there, the file is handed over through the network 4′ to the viewer manager 13 in the communicator 3.

This view manager 13 activates a viewer program 14 in accordance with a kind of the file thus received, to display this received file through the projector 2. In this case, a name of this file is simultaneously posted to the notebook personal computers PC1-PC3 of all the clients connected to the network 4′ and added to the file list 16 of each client GUI program 12 and, the “On Air” mark 17 indicating that this file is currently projected is displayed at the bottom of the GUI-operation screen P1. This operation can be performed even when any one of the clients is making a presentation. For example, if a material B is transferred to the communicator 3 by the above-mentioned operation when a material A is being explained, a name of the material B is added to the file list 16 of all the clients.

Further, when a conference attendee selects a name of a material in the file list 16 in his or her own client GUI program 12, this operation is transferred to the viewer manager 13 to switch a view program window in which the corresponding material is open to a most anterior window, thus enabling switching materials being projected. In this case, the view manager 13 posts a switched condition to all the clients, so that the GUI program 12 of each of the clients alters a display position of the mark 17 indicating current projection.

In such a manner, according to the electronic conference system 102 of the fourth implementation example related to the present invention, on the assumption that the communicator 3 arranged in a conference room, a classroom, etc. shown in FIG. 6 and each of the notebook personal computers PC1-PC3 provided in the conference room are connected to each other by the network 4′, the notebook personal computer PC1 etc. utilizes its GUI functions to remote-control information record (simultaneous connectivity). Therefore, information transferred from a plurality of notebook personal computers can be kept in the communicator 3. It is thus possible to transfer information of materials etc. obtained from a plurality of attendees involved in network information processing to the communicator 3 smoothly and systematically.

According to this example, without connecting terminal equipment to each of the projectors 2 one by one in the conventional way, a plurality of conference attendees can transfer a plurality of materials of their own to the same communicator 3 and easily switch them in display. It is thus made possible to realize operations of a plurality of materials by a plurality of attendees, which has been impossible by conventional presentation apparatuses. Furthermore, display of material information can be switched easily and, simultaneous connectivity of a network can be utilized to permit all the attendees to switch materials, thereby realizing smooth proceeding of a conference.

### (6) FIFTH IMPLEMENTATION

According to a fifth implementation example related to the present invention, in the earlier-mentioned electronic conference system 102, one specific file is activated at another notebook personal computer PC1 etc. beforehand, so that pieces of capture information transferred from this notebook personal computer PC1 etc. are pasted to the file consecutively, thus displaying an image. In such a manner, image information in the notebook personal computer PC1 can be transferred without being transformed into a data file, thereby increasing a display speed. It is made possible to perform network information processing smoothly even if a communicator 3 is shared by the plurality of notebook personal computers PC1. A GUI-operation screen (activation-time screen) P0 described with reference to FIG. 4 is referenced here again. The other system configuration components are such as shown in FIG. 6 and the description thereof is omitted.

The following will describe an example of display remote-control by use of GUI functions of the notebook personal computer PC1 etc. in the electronic conference system 102. In this example also, presentation data is projected through a projector 2, so that the following processing is performed. Dedicated application software is activated at each of the notebook personal computers PCi beforehand, to put a GUI-operation screen P2 such as shown in FIG. 4 in a screen-snap mode. Then, on a keyboard of the notebook personal computer PCi, a print screen key is pressed alone or with an ALT key held down. Then, from the communicator 3, information of an entire screen or an active window screen is copied and transferred. At the communicator 3, a JPEG viewer is activated. To a JPEG data file, the screen information is pasted, so that a capture image is displayed through the projector 2. Then, the print screen key is pressed alone or with the ALT key held down, to copy and transfer information of the entire screen or the active window screen to the communicator 3, which processing is repeated; however, the JPEG viewer is not activated newly, so that the screen information is only copied and transferred into the same file. Note here that almost the same processing is performed even if no input operation is performed at any other notebook personal computer PCi. When consecutive operations are performed, the process waits until the previous screen information is displayed.

In such a manner, according to the electronic conference system 102 of the fifth implementation example related to the present invention, one specific file is activated at any other notebook personal computer PC1 etc. beforehand, so that pieces of the capture information transferred from this notebook personal computer PC1 etc. are pasted to a file consecutively. Therefore, screen information of the notebook personal computer PCi can be transferred without being transformed into a data file, thereby increasing the display speed. Network information processing can be performed smoothly even if the communicator 3 is shared a presentation by the plurality of notebook personal computers PCi.

### (7) SIXTH IMPLEMENTATION EXAMPLE

In this implementation example, in a case where a target personal computer for providing electronic information contents to a plurality of console personal computers and each of the console personal computers are connected to each other by communication means, a communication management/control apparatus is provided between the console personal computers and the target personal computer. This communication management/control apparatus monitors a request for input operation from any console personal computer and invests with the operating right the console personal computer sending the request for input operation. In such a manner, the console personal computer which is invested with the operating right can simultaneously remote-control a plurality of arbitrary target personal computers exclusively with it having preference over the other console personal computers. Besides, it is also possible to transmit and receive electronic information contents smoothly and efficiently in a case where a variety of kinds of network conference systems, network education systems, network game systems, etc. are built up between remote locations.

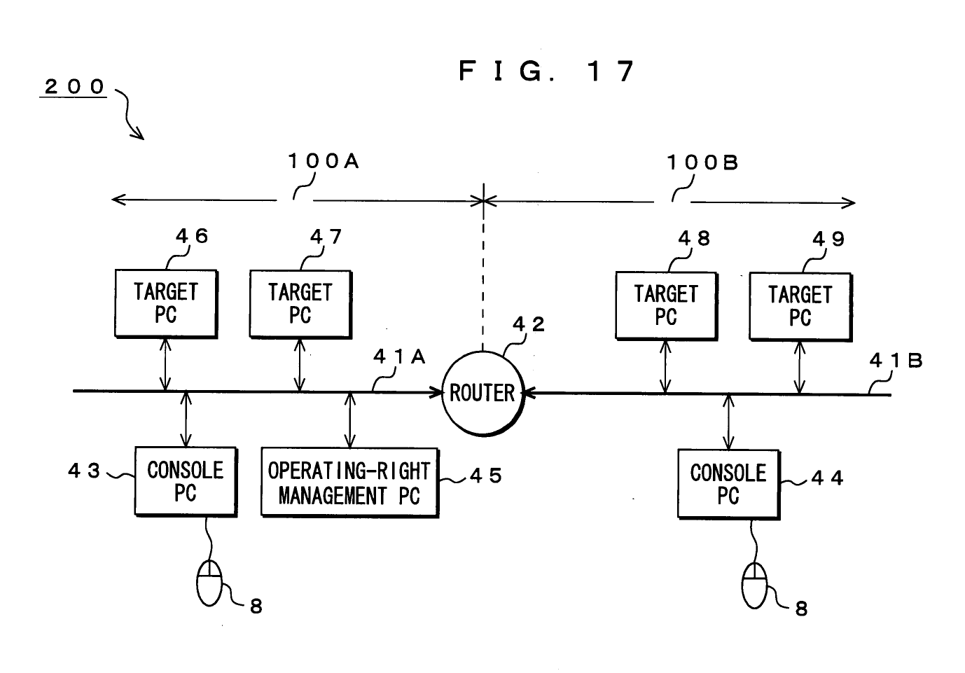

In a network information processing system 200 shown in FIG. 17, two network information processing systems 100A and 100B are connected to each other, as described with reference to the embodiment, via communication cables 41A and 41B and a router 42, which constitute communication means. The communications cables 41A and 41B, the router 42, etc. constitute a network. One network information processing system 100A is provided with a console personal computer (hereinafter referred to as console PC) 43, which is one example of information processors, for sending remote-operation via a network and has input operation functions of this console PC43 to process arbitrary information. At the console PC 43, operations of the mouse and the keyboard performed in a remote-operation window are transmitted to a target PC. In a configuration of the electronic conference system, the console PC43 corresponds to a presenter.

This console PC 43 is connected to the communication means 41A, and at least a plurality of target personal computers (hereinafter refereed to as target PCs) 46 and 47, which is one example of an information provision apparatus, is connected to the communication means 41A, thereby receiving the remote-operation via a network, and providing electronic information contents to a console PC 44 of the other network information processing system 100B etc. The target PC 46 etc. have a projector connected thereto and uses it to display presentation materials etc.

In this network information processing system 100B, to the communication means 41B are connected at least the console PC 44 and a plurality of target PCs 48 and 49, which is one example of the information provision apparatus, thereby providing electronic information contents transferred from the network information processing system 100A to the console PC 44. The target PCs 46-49 correspond to the main communicator 3 described with reference to the first through fifth implementation examples. Hereinafter, there are some cases where the target PC46 etc. may correspond to a sub-communicator for assisting the main communicator 3 or co-operating with it.

Further, to the communication means 41A, an operating-right management personal computer (hereinafter referred to as operating-right PC) 45, which is one example of communication management/control apparatus, is connected, to control a communication between the console PC 43 and the target PCs 46-49. In particular, the operating-right management PC 45 gives the operating right to the console PC 43 exclusively. The operating-right management PC 45 permits only one of the plurality of console PCs 43, 44, etc., if the plurality of console PCs are present in a network, to transmit data to the target PCs 46-49. In the configuration of the electronic conference system, the main communicator 3 corresponds to this. For example, the operating-right management PC45 receives a request for input operation from the console PCs 43 and 44 and invests with the operating right these console PCs 43 and 44 sending the request for input operating.

In this system 200, input operations by a specific console PC 43 which is invested with the operating right cause electronic information contents to be transmitted (broadcast) to the plurality of target PCs 46-49 all at once. It is done so in order to provide the electronic information contents to the console PCs 43, 44, etc. in the network information processing system 100B. When the input operations by the specific console PC 43 which is invested with the operating right in this system are finished, the operating right can be given to any other console PC 44.

In this system 200, the operating-right management PC45 detects a completion notification obtained from the console PC 43 which is invested with the operating right and, when this completion notification is detected, the operating right is open to the other console PC 44. It is thus possible to decrease an operation time. lag from a moment when input operations by the console PC 43 to which the operating right is returned are finished to a moment when it becomes possible to receive a request for input operation from the other console PC 44. Therefore, a plurality of attendees can alternately obtain the operating right to remote-control the target PCs 46-49.

Further, the operating-right management PC45, if provided with information processing assisting functions, can assist electronic information processing including display information based on an input operation instruction obtained from the console PCs 43 and 44. That is, this operating-right management function is provided to the communicator 3 described with reference to the first through fifth implementation examples. In this example, the console PCs43 and 44 are each provided with a movable mouse 8 described with reference to the first through fifth implementation examples so that coordinates of an operation position may be entered. The console PCs43 and 44 detect an amount of movement of the mouse 8 and compare a detected amount of movement to a preset reference amount of movement and, if the detected amount of movement exceeds the reference amount of movement, they transfer coordinates of operation positions obtained by sampling the mouse 8 at a constant interval. Therefore, in transfer of information of operation position coordinates by movement operations of the mouse 8, even if a lot of movement operations have occurred, not all of them are transferred but operation position coordinates obtained by sampling the mouse at the constant interval are transferred instead, thus enabling data transfer without inflicting too much loads on the network.

In this example, the sampling of the mouse 8 may vary according to a traffic condition in this network processing system 200. For example, by varying a sampling period (time interval) of the mouse 8 in accordance with the network traffic condition, loads on the network can be reduced to a minimum. In such a manner, by utilizing this means at the network-type communicators (target PCs 46-49) 3, a display material at any one of the communicators 3 that is viewed by someone can be operated, thereby simultaneously operating materials displayed at the communicator 3 at a remote location.

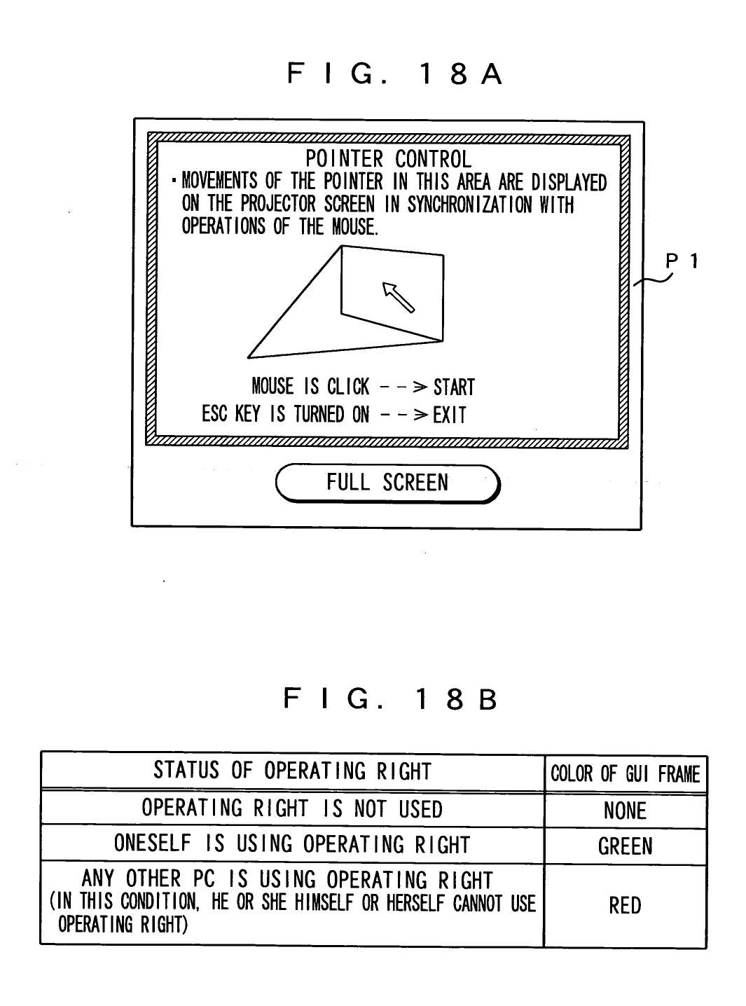

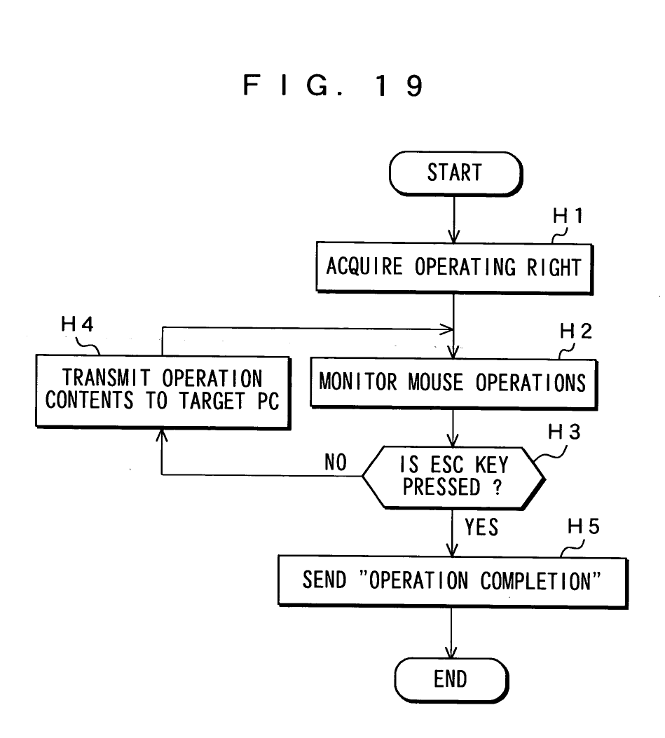

The following will describe an example of display on the GUI-operation screen P1 at the console PC43 etc. In this example, if someone acquires the operating right and selects the GUI-operation screen P1 shown in FIG. 18A, a color of an outer frame of the GUI-operation screen P1 shown in FIG. 7 earlier changes. That is, in a table as indicated in FIG. 18B, if the operating right is not used, the color of the outer frame of the GUI-operation screen P1 remains unchanged. If he or she himself or herself uses the operating right as a presenter, the outer frame of the GUI-operation screen P1 turns green in display. If the other console PC43 etc. uses the operating right, the outer frame of the GUI-operation screen P1 turns red in display. In this state, he or she cannot acquire his or her own operating right. In this example, the state of exercising the operating right can be determined immediately by the color of the outer frame of the GUI-operation screen P1.

The following will describe, as processing examples in this network information processing system 200, a processing example of mouse operations at the console PC43 etc. and a processing example at the target PCs46-49 etc. In this example, it is assumed that transfer of operations via the network is performed in accordance with the following rules.

(a) A UDP communication protocol is utilized for transferring movements of the mouse to the target PCs 46-49 present in a local segment while a TCP communication protocol is utilized for transferring the other operations. It is done so that in a case where an operator of the console PC 43 etc. is assumed to perform operations as referencing the screens of the target PCs46-49 present in a local segment, a time lag between mouse movement on the console PC43 etc. and that on the screens of the target PCs 46-49 may be reduced to a minimum and operations of the mouse button or the keyboard may be transferred to the target PCs 46-49 securely.

(b) The TCP communication protocol is utilized in all cases for transferring operations to the target PCs 46-49 present in a remote segment. It is done so in order to improve reliabilities of data transfer rather than a response to the operations, to keep the operation condition in synchronization with the target PCs 46-49 in a local segment.

(c) The console PCs 43 and 44 having the operating right each notify the operating-right management PC 45 of their operation condition at a constant interval no matter whether they have operated. If sending of this notification of the operation condition is stopped, the operating-right management PC45 decides that the console having the operating right encounters a failure and places back the operating right into an unused condition. By this processing, even if a failure occurs on the console PC43 having the operating right, any other console PC44 etc. can continue the operation.

(d) In transfer of movement operations of the mouse, not all of, them are transferred and, if a lot of movement operations have occurred, a position of the mouse is sampled at a constant time interval, to transfer only resultantly obtained coordinates. The sampling time interval is varied with the traffic condition of the network to reduce loads on the network to a minimum.

In this example, of course, in a case where the plurality of console PCs 43 and 44 having the mouse 8 to process arbitrary information and at least the target PCs 46-49 that provide network information to these console PCs 43 and 44 are connected to each other by the communication means 41A and 41B and the router 42, communication is controlled by the operating-right management PC 45 between the console PC 43 and the target PCs46-49 that are connected to each other by this communication means 41A. Based on such assumption, the operating-right management PC 45 receives a request for input operation from the console PC 43 or PC 44 and invests with the operating right the console PC 43 or PC 44 sending this request for input operation. For example, the operating-right management PC 45 invests with the operating right the console PC 43 that has transmitted the request for input operation earliest. Subsequently, the following processing is performed to operate the target PCs 46-49 from the console PC 43.

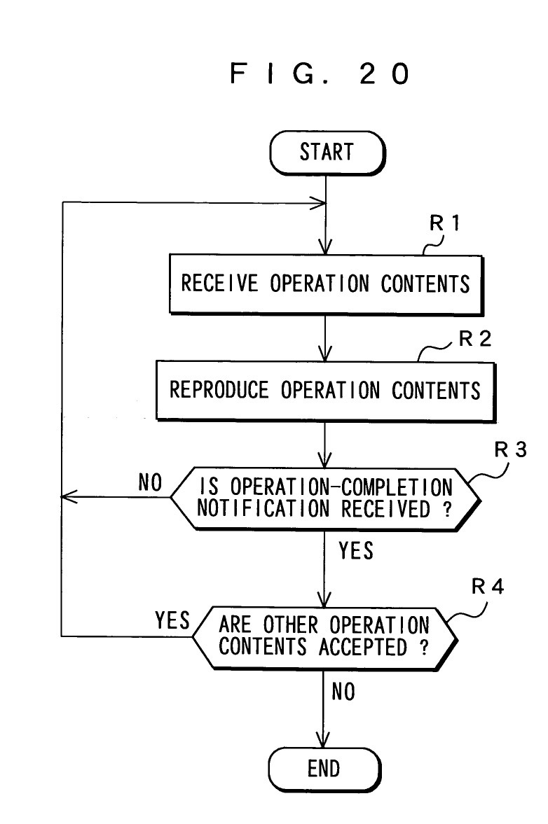

First, at the console PC43, the GUI-operation screen P1 shown in FIG. 18A is displayed and, at step H1 of a flowchart shown in FIG. 19, the mouse 8 is operated to acquire the operating right. For example, if the GUI-operation screen P1 shown in FIG. 18A at the console PC43 has no outer frame, the process moves the mouse 8 into its region and clicks the mouse to acquire the operating right. A condition of the operating right in this case can be confirmed intuitively because the outer frame of the GUI-operation screen P1 turns green as indicated in FIG. 18B. Note here that in the console PC43, IP addresses of the target PCs46-49 are registered as many as required.

Then, the process goes to step H2 to monitor operations of the mouse in every constant lapse of time. Then, the process goes to step H3 to check whether the ESC key is pressed. If the ESC key is not pressed, the process goes to step H4 to transfer contents of the key board operations subsequently and the operations of the mouse 8 performed in the frame of the GUI-operation screen P1 to the target PCs 46-49 via the network. Then, the process goes to step H2 to monitor mouse operation continuously. Then, at step H3, the process releases the operating right at the console PC 43 if the ESC key is pressed. At step H5, the process sends an “operation completion notification” and ends the processing. Note here that the operating-right management PC 45 periodically broadcasts the status of the operating right. Therefore, when “operation completion” of the console PC 43 is received, such a state is entered that the operating right can be handed over to any other console PC 44 etc.

On the other hand, the target PC 46 etc. receives operation contents transferred from the console PC 43 etc. at step R1 of a flowchart shown in FIG. 20. Then, the process goes to step R2 to reproduce operation contents (electronic information contents). Then, the process goes to step R3 to check whether an operation completion notification is received from the console PC 43, in accordance with a known method. If no operation completion notification is received, the process returns to step R1 to receive operation contents continuously and, goes to step R2 to reproduce the operation contents. If an operation completion notification is received from the console PC 43, the process goes to step R4 to check whether any other operation contents are to be accepted. If such is the case, the process returns to step R1 to receive operation contents and, repeatedly, goes to step R2 to reproduce the operation contents. If a system processing completion notification etc. are received from the operating-right management PC 45 so that any other operation contents may not be accepted, the process ends this system processing.

In such a manner, according to the network information processing system 200 of the sixth implementation example related to the present invention, the operating-right management PC 45 monitors a request for input operation obtained from the console PCs 43 etc. and invests with the operating right the console PC 43 sending the request for input operation. Therefore, a person who operates this console PC43 invested with the operating right can remote-control one or more arbitrary target PCs 46-49 exclusively with it having preference over the other console PCs 44 (persons who operate them).

Furthermore, it is possible to transfer input operation information of the mouse, the keyboard, etc. simultaneously to the plurality of target PCs 46-49 from the console PC 43 etc. of an attendee of an electronic conference system etc., so that the plurality of target PCs 46-49 can be remote-controlled simultaneously by the console PC43 etc. It is thus possible to transmit and receive electronic information contents smoothly and efficiently even in a case where a variety of kinds of network conference systems, network education systems, network game systems, etc. are built up between remote locations.

Although the above network information processing system has been described with reference to an electronic conference system, the present invention is not limited to it; for example, the present invention can be applied also to a network education system, a network game system, etc.

### INDUSTRIAL APPLICABILITY

The present invention is extremely well applicable to a variety of kinds of network conference systems, network education systems, network game systems, etc.

1. A network information processing system comprising:
at least one information processor having an input operation function and processing arbitrary information;
information provision management means for processing at least information transferred from said information processor and providing electronic information contents including display information; and
communication means for connecting said information provision management means and each of said information processors to each other, wherein said information provision management means is remote-controlled exclusively or cooperatively utilizing said input operation function of said information processor.

2. The network information processing system according to claim 1, wherein said information provision management means comprises:
display for displaying an image based on information transferred from said information processor; and
an information processing assisting apparatus for assisting electronic information processing including said display based on an input operation instruction obtained from said information processor.

3. The network information processing system according to claim 2, wherein said information processors are each assigned unique identification information; and
wherein said information processing assisting apparatus manages and controls each of said information processors based on said unique identification information.

4. The network information processing system according to claim 1, wherein said communication means employs any one of a wire system and a wireless system.

5. The network information processing system according to claim 1, wherein as said communication means, a wireless LAN card is used.

6. The network information processing system according to claim 1, wherein to each of said information processors, operation-restriction information that is allowed to be released by specific key information is set.

7. The network information processing system according to claim 1, wherein said information processor is provided with input means, said input means having operation information input by selecting an icon image on a user-selecting screen.

8. The network information processing system according to claim 1, wherein said information provision management means is remote-controlled simultaneously utilizing input operation functions of said information processor and another information processor.

9. A network information processing method comprising the steps: connecting to each other at least one information processor having an input operation function and processing arbitrary information and information provision management means for processing at least information transferred from said information processor and providing electronic information contents including display information; and
remote-controlling said information provision management means exclusively or cooperatively based on an input operation obtained from said information processor.

10. The network information processing method according to claim 9, wherein said information provision management means uses:
a display for displaying an image based on information transferred from said information processor; and
an information processing assisting apparatus for assisting electronic information processing including display processing in said display based on an operation instruction obtained from said information processor.

11. The network information processing method according to claim 9, wherein said communication means employs any one of a wire system and a wireless system.

12. The network information processing method according to claim 9, wherein said information processors are each assigned unique identification information; and
wherein said information processing assisting apparatus manages and controls each of said information processors based on said unique identification information.

13. The network information processing method according to claim 9, wherein to each of said information processors, operation-restriction information that is allowed to be released by specific key information is set.

14. A network information processing system comprising:
at least one information processor having an input operation function and processing arbitrary information;
information provision management means for processing at least information transferred from said information processor and providing electronic information contents including display information; and
communication means for connecting said information provision management means and each of said information processors to each other, wherein utilizing said input operation function of said information processor, a participation right is set remotely for each of said network information processing systems.

15. The network information processing system according to claim 14, wherein said information provision management system comprises:
display for displaying an image based on information transferred from said information processor; and
an information processing assisting apparatus for assisting electronic information processing including display processing in said display based on an input operation instruction obtained from said information processor.

16. The network information processing system according to claim 14, wherein said information provision management means collates with each other a participation right which is initially set and a participation right which is set next time and beyond; and
wherein information is processed, said information being transferred from an information processor having said participation right that has agreed with said initially set participation right.

17. The network information processing system according to claim 14, wherein said participation right is remote-controlled at said information provision management means.

18. The network information processing system according to claim 14, wherein said information provision management means invalidates said participation right when a specific information processor that is given said participation right finishes its input operation.

19. The network information processing system according to claim 14, wherein after a constant lapse of time from a point in time when relevant network information processing has been finished, said information provision management means invalidates all of said participation rights.

20. The network information processing system according to claim 14, wherein said communication means employs any one of a wire system and a wireless system.

21. The network information processing system according to claim 14, wherein as said communication means, a wireless LAN card is used.

22. A network information processing method comprising the steps of:
connecting at least one information processor and information provision management means to each other using communication means, said information processor having an input operation function and processing arbitrary information and said information provision management means processing at least information transferred from said information processor and providing electronic information contents including display information; and
remotely setting a participation right for each network information processing system comprising said information processor, said information provision management means, and said communication mean, by utilizing said input operation function of said information processor.

23. The network information processing method according to claim 22, wherein said information provision management means collates with each other a participation right which is initially set and a participation right which is set next time and beyond; and
wherein information is processed, said information being transferred from an information processor having said participation right that has agreed with said initially set participation right.

24. The network infromation processing method according to claim 22, wherein said participation right is remote-controlled at said information provision management means

25. The network information processing method according to claim 22, wherein said infromation provision management means invalidates said particaipation right when a specific information processor that is given said participation right finishes its input operation

26. The network information processing method according to claim 22, wherein after a constant lapse of time from a point in time when relevant network information processing has been finished, said information provision management means invalidates all of said participation rights.

27. The network information processing method according to clain 22, wherein a first attendee involved in said network information processing is given a right to set said participation right.
